(19) United States
(12) Patent Application Publication
(10) Pub. No.: US 2023/0331967 A1
(43) Pub. Date: Oct. 19, 2023

(54) POLYETHYLENE-BASED-RESIN COMPOSITION, POLYETHYLENE-BASED-RESIN PACKAGING MATERIAL, AND METHOD FOR PRODUCING SAME

(71) Applicant: SANIPAK COMPANY OF JAPAN, LTD., Tokyo (JP)

(72) Inventors: Yoshihiro HORIGOME, Tokyo (JP); Manabu OSAKI, Tokyo (JP); Keisuke YAMAMOTO, Tokyo (JP); Yasuhiro NAKAGAWA, Tokyo (JP)

(21) Appl. No.: 18/026,090

(22) PCT Filed: Sep. 16, 2020
(86) PCT No.: PCT/JP2020/035075

§ 371 Date: Mar. 13, 2023

(51) Int. Cl. C08L 23/06

(52) U.S. Cl. CPC C08L 23/06; C08L 2205/025; C08L 2207/062; C08L 2207/066

(57) ABSTRACT

An object of the present invention is to provide a polyethylene-based resin composition from which a film can be obtained which has excellent moldability even in a case where an inorganic compound is added, and has excellent bag-making processability and film strength; and a polyethylene-based resin packaging material formed of the polyethylene-based resin composition. In a polyethylene-based resin composition containing an inorganic compound and an ethylene-α-olefin copolymer, the amount of a resin component is 25% by mass or more and less than 90% by mass, a proportion of the ethylene-α-olefin copolymer in the resin component is 50% by mass or more, and a proportion of an ethylene-α-olefin copolymer A polymerized with a metallocene-based catalyst in the ethylene-α-olefin copolymer is 10% by mass or more.

### TECHNICAL FIELD

The present invention relates to a polyethylene-based resin composition, a polyethylene-based resin packaging material, and a method for producing the same.

### BACKGROUND ART

A polyethylene-based resin packaging material has been used in many applications including garbage bags, shopping bags, and fashion bags. In recent years, with global warming, there is a strong demand to reduce the amount of carbon dioxide generated, and it is important to suppress the amount of resin used. As a method for reducing the amount of resin used, a method of adding an inorganic compound to the resin while ensuring moldability has been known. Patent Documents 1 and 2 disclose adding calcium carbonate to the resin.

### CITATION LIST

### Patent Documents

### [Patent Document 1]

Japanese Patent No. 3366942

### [Patent Document 2]

Japanese Unexamined Patent Application, First Publication No. 2018-21121

### SUMMARY OF INVENTION

### Technical Problem

However, the film containing calcium carbonate of Patent Document 1 is inferior in bag-making processability by heat sealing. In addition, the film containing calcium carbonate of Patent Document 2 is inferior in film strength.

An object of the present invention is to provide a polyethylene-based resin composition from which a film can be obtained which has excellent moldability even in a case where an inorganic compound is added, and has excellent bag-making processability and film strength; a polyethylene-based resin packaging material formed of the polyethylene-based resin composition; and methods for producing these.

### Solution to Problem

In the present invention, it is found that, in a resin composition, by using an ethylene-α-olefin copolymer A polymerized with a metallocene-based catalyst in a specific ratio, it is possible to obtain a polyethylene-based resin packaging material in which excellent moldability and bag-making processability are ensured even in a case where an inorganic compound is contained, and which has excellent film strength.

The present invention has the following aspects.

A polyethylene-based resin composition containing an inorganic compound and a resin component, in which the amount of the resin component is 25% by mass or more and less than 90% by mass with respect to the total mass of the resin composition, the resin component includes an ethylene-u-olefin copolymer in an amount of 50% by mass or more with respect to the total mass of the resin component. and 10% by mass or more of the ethylene-α-olefin copolymer is an ethylene-α-olefin copolymer A polymerized with a metallocene-based catalyst.

The polyethylene-based resin composition according to [1], in which α-olefin used in the ethylene-α-olefin copolymer A has 6 or more and 8 or less carbon atoms.

The polyethylene-based resin composition according to [1] or [2], in which the inorganic compound is calcium carbonate.

A polyethylene-based resin packaging material formed from the polyethylene-based resin composition according to any one of [1] to [3].

The polyethylene-based resin packaging material according to [4], in which the polyethylene-based resin packaging material is for a garbage bag, a shopping bag, a fashion bag, a storage bag, or a packing bag.

A method for producing a polyethylene-based resin composition containing an inorganic compound and a resin component, the method including mixing the resin component and the inorganic compound in amounts in which the amount of the resin component is 25% by mass or more and less than 90% by mass with respect to the total mass of the resin composition, in which the resin component includes an ethylene-α-olefin copolymer in an amount of 50% by mass or more with respect to the total mass of the resin component, and 10% by mass or more of the ethylene-α-olefin copolymer is an ethylene-α-olefin copolymer A polymerized with a metallocene-based catalyst.

A method for producing a polyethylene-based resin packaging material, including producing a polyethylene-based resin composition by the method for producing a polyethylene-based resin composition according to [6], and molding the polyethylene-based resin composition to obtain a polyethylene-based resin packaging material.

### ADVANTAGEOUS EFFECTS OF INVENTION

According to the present invention, it is possible to provide a polyethylene-based resin composition from which a film can be obtained which has excellent moldability even in a case where an inorganic compound is added, and has excellent bag-making processability and film strength; a polyethylene-based resin packaging material formed of the polyethylene-based resin composition; and methods for producing these.

### DESCRIPTION OF EMBODIMENTS

### Polyethylene-Based Resin Composition

The polyethylene-based resin composition (hereinafter, referred to as “PE-based resin composition”) according to the embodiment of the present invention contains an inorganic compound and a resin component.

The resin component includes an ethylene-α-olefin copolymer. The ethylene-α-olefin copolymer is a copolymer obtained by a copolymerization using ethylene and α-olefin, and is preferably linear low density polyethylene (LLDPE). At least a part of the ethylene-α-olefin copolymer contained in the PE-based resin composition according to the embodiment of the present invention is an ethylene-α-olefin copolymer A (hereinafter, referred to as “copolymer A”) polymerized with a metallocene-based catalyst.

From the viewpoint of excellent moldability of the PE-based resin composition, and viewpoint that it is easy to obtain a film having excellent bag-making processability and film strength, the number of carbon atoms in α-olefin used in the copolymer A is preferably 6 or more and 8 or less. As the α-olefin used in the copolymer A. specifically, 1-hexene and 1-octene are exemplary examples. The α-olefin used in the copolymer A may be of one type, or two or more types.

MFR of the copolymer A is preferably 0.8 g/10 min or more and 4.0 g/10 min or less, more preferably 0.8 g/10 min or more and 2.0 g/10 min or less, still more preferably 0.8 g/10 min or more and 1.5 g/10 min or less, and particularly preferably 0.8 g/10 min or more and 1.2 g/10 min or less. In a case where the MFR of the copolymer A is equal to or more than the lower limit value of the above-described range, excellent moldability can be ensured even at a low molding temperature, so that deterioration of the copolymer A can be easily suppressed. In a case where the MFR of the copolymer A is equal to or less than the upper limit value of the above-described range, melt tension is not too low, so that molding of the film is easier.

The MFR is a value obtained by applying a load of 2.16 kg to a resin (polymer) heated to 190° C. and measuring the amount of resin flowing out from an orifice with a diameter of 2.09 mm in 10 min.

A melting point of the copolymer A is preferably 90° C. or higher and 130° C. or lower, and more preferably 100° C. or higher and 125° C. or lower. In a case where the melting point of the copolymer A is equal to or more than the lower limit value of the above-described range, the shape of heat-sealed bag is good. In a case where the melting point of the copolymer A is equal to or less than the upper limit value of the above-described range, the heat-sealing time can be shortened, and bag-making speed (production speed) is improved.

The melting point is a temperature corresponding to a melting peak measured by differential scanning calorimetry (DSC).

The copolymer A can be manufactured by a known method, except that the metallocene-based catalyst is used as a polymerization catalyst. As the polymerization method, any known method can be adopted without limitation, and among these, a gas phase polymerization method is preferable. The polymerization to obtain the copolymer A may be a one-stage polymerization or a multi-stage polymerization of two or more stages.

The metallocene-based catalyst is a catalyst containing a metallocene complex. As the metallocene-based catalyst, any known metallocene-based catalyst can be used, and a combination of a metallocene complex and a co-catalyst may also be used.

As specific examples of the metallocene complex, complexes in which a ligand having a cyclopentadiene skeleton such as methylcyclopentadiene, dimethyleyelopentadiene, and indene is coordinated to a transition metal such as Ti, Zr, and Hf are exemplary examples. The metallocene complex used for the polymerization may be of one type, or two or more types.

As the co-catalyst, organometallic compounds of Groups 1 to 3 elements of the periodic table, such as aluminoxane, are exemplary examples. The co-catalyst used for the polymerization may be of one type, or two or more types.

As the metallocene-based catalyst, a supported catalyst supported on a carrier such as silica may be used.

As the copolymer A, LLDPE polymerized with a metallocene-based catalyst, in which the number of carbon atoms in α-olefin is 6 (m-C6-LLDPE) and LLDPE polymerized with a metallocene-based catalyst, in which the number of carbon atoms in α-olefin is 8 (m-C8-LLDPE) are exemplary examples.

The copolymer A contained in the PE-based resin composition may be of one type, or two or more types.

The resin component may include an ethylene-α-olefin copolymer B other than the copolymer A (hereinafter, referred to as “copolymer B”).

As the copolymer B, ethylene-α-olefin copolymers polymerized with a catalyst other than the metallocene-based catalyst are exemplary examples. As the catalyst other than the metallocene-based catalyst, a Ziegler-type catalyst and a Phillips-type catalyst are exemplary examples, and a Ziegler-type catalyst is preferable. A method for polymerizing the copolymer B is not particularly limited, and a solution polymerization method, a slurry polymerization method, a gas phase polymerization method, and a highpressure ion polymerization method are exemplary examples.

From the viewpoint of excellent moldability of the PE-based resin composition, and viewpoint that it is easy to obtain a film having excellent bag-making processability and film strength, the number of carbon atoms in α-olefin used in the copolymer B is preferably 4 or more and 8 or less. Specific examples of the α-olefin are the same ones as exemplary examples in the copolymer A. The α-olefin used in the copolymer B may be of one type, or two or more types.

As the copolymer B, LLDPE polymerized with a catalyst other than the metallocene-based catalyst, in which the number of carbon atoms in α-olefin is 4 (C4-LLDPE). LLDPE polymerized with a catalyst other than the metallocene-based catalyst, in which the number of carbon atoms in α-olefin is 6 (C6-LLDPE), and LLDPE polymerized with a catalyst other than the metallocene-based catalyst, in which the number of carbon atoms in α-olefin is 8 (C8-LLDPE) are exemplary examples.

The copolymer B contained in the PE-based resin composition may be of one type, or two or more types. As the copolymer B, a recycled product can also be used.

As long as it does not impair the effects of the present invention, the resin component may include a high-density polyethylene (HDPE), a low-density polyethylene (LDPE), an ultra-low-density polyethylene (VLDPE), an ethylene-vinyl acetate resin (EVA), an ethylene-vinyl alcohol copolymer (EVOH), an ethylene-propylene copolymer, or the like, in addition to the copolymer A. As these other polymers, a recycled product can also be used.

As the resin component contained in the PE-based resin composition according to the embodiment of the present invention, the copolymer A alone, a combination of the copolymer A and the copolymer B, a combination of the copolymer A and HDPE, or a combination of the copolymer A, the copolymer B. and HDPE is preferable.

A proportion of the ethylene-α-olefin copolymer in the resin component is 50% by mass or more with respect to the total mass of the resin component, preferably 50% by mass or more and 100% by mass or less, and more preferably 55% by mass or more and 100% by mass or less. In a case where the proportion of the ethylene-α-olefin copolymer is equal to or more than the lower limit value of the above-described range, a film having excellent film strength is obtained. In a case where the proportion of the ethylene-α-olefin copolymer is equal to or less than the upper limit value of the above-described range, a film having excellent film moldability and bag-making properties is obtained.

A proportion of the copolymer A in the ethylene-α-olefin copolymer is 10% by mass or more with respect to the total mass of the ethylene-α-olefin copolymer, preferably 10% by mass or more and 100% by mass or less, and more preferably 13% by mass or more and 100% by mass or less. In a case where the proportion of the copolymer A is equal to or more than the lower limit value of the above-described range, a film having excellent film strength is obtained. In a case where the proportion of the copolymer A is equal to or less than the upper limit value of the above-described range, a film having excellent film moldability and bag-making properties is obtained.

In a case where the PE-based resin composition according to the embodiment of the present invention contains the copolymer B. a proportion of the copolymer B in the ethylene-α-olefin copolymer is preferably 15% by mass or more and 90% by mass or less, and more preferably 20% by mass or more and 90% by mass or less with respect to the total mass of the ethylene-α-olefin copolymer. In a case where the proportion of the copolymer B is equal to or more than the lower limit value of the above-described range, stable moldability is obtained. In a case where the proportion of the copolymer B is equal to or less than the upper limit value of the above-described range, sufficient film strength is obtained.

In a case where the PE-based resin composition according to the embodiment of the present invention contains HDPE, a proportion of HDPE in the resin component is preferably 5% by mass or more and 50% by mass or less, and more preferably 8% by mass or more and 45% by mass or less with respect to the total mass of the resin component. In a case where the proportion of HDPE is equal to or more than the lower limit value of the above-described range, bag-making properties of the film are stabilized. In a case where the proportion of HDPE is equal to or less than the upper limit value of the above-described range, sufficient film strength is obtained.

The amount of the resin component in the PE-based resin composition is 25% by mass or more and less than 90% by mass with respect to the total mass of the PE-based resin composition, preferably 25% by mass or more and 85% by mass or less, and more preferably 25% by mass or more and 80% by mass or less. In a case where the amount of the resin component is equal to or more than the lower limit value of the above-described range, the moldability is excellent and sufficient film strength is likely to be obtained. In a case where the amount of the resin component is equal to or less than the upper limit value of the above-described range, the effect of suppressing the amount of resin used is sufficiently obtained.

The inorganic compound contained in the PE-based resin composition is not particularly limited, and calcium carbonate, titanium oxide, silica, clay, talc, kaolin, and aluminum hydroxide are exemplary examples. Among these, calcium carbonate is preferable. The inorganic compound may be used alone, or in combination of two or more kinds thereof.

The calcium carbonate may be so-called heavy calcium carbonate obtained by mechanically pulverizing limestone, or so-called precipitated calcium carbonate obtained by a carbonation method. The calcium carbonate may be surface-treated, or may not be surface-treated. The calcium carbonate may be used alone, or in combination of two or more kinds thereof.

An average particle size of the calcium carbonate is preferably 5.0 µm or less, and more preferably 3.0 µm or less. In a case where the average particle size of the calcium carbonate is equal to or less than the upper limit value of the above-described range, excellent moldability can be ensured, and defects such as aggregation, holes caused by the size of the particles themselves, and poor appearance are less likely to occur during film molding. The lower limit of the average particle size of the calcium carbonate is preferably 0.1 µm. The average particle size of the calcium carbonate is preferably 0.1 µm or more and 5.0 µm or less. The average particle size of the calcium carbonate is measured by an air permeation method.

A top-cut particle size of the calcium carbonate is preferably 15 µm or less, and more preferably 10 µm or less. The top-cut particle size is measured with an X-ray transmission particle size distribution analyzer.

A 45 µm-sieve residue of the calcium carbonate is preferably 0.01% by mass or less. The 45 µm-sieve residue is measured using a JIS standard sieve.

The amount of the inorganic compound in the PE-based resin composition according to the embodiment of the present invention is preferably more than 10% by mass and 75% by mass or less, and more preferably 15% by mass or more and 75% by mass or less with respect to the total mass of the resin composition. In a case where the amount of the inorganic compound is equal to or more than the lower limit value of the above-described range, the effect of suppressing the amount of resin used is sufficiently obtained. In a case where the amount of the inorganic compound is equal to or less than the upper limit value of the above-described range, sufficient film strength is obtained.

The PE-based resin composition according to the embodiment of the present invention may contain an additive as necessary. As the additive, an antioxidant, a light stabilizer, a lubricant, a dispemant, a pigment, an antistatic agent, a desiccant, and an animal repellent are exemplary examples. The additive may be of one kind, or two or more kinds.

The amount of the additive in the PE-based resin composition according to the embodiment of the present invention is preferably 3% by mass or less, and more preferably 1% by mass or less with respect to the total mass of the PE-based resin composition.

A method for producing the PE-based resin composition according to the embodiment of the present invention is not particularly limited, and methods of mixing each component with a single-screw extruder, a multi-screw extruder, a Banbury mixer, a kneader, or the like such that the above-described composition is satisfied are exemplary examples. A part of the resin component may be mixed in advance with the inorganic compound or the additive to prepare a masterbatch, and the masterbatch and the rest of the resin component may be mixed.

The mixing temperature during production of the PE-based resin composition can be adjusted as appropriate, for example. 150° C. or higher and 190° C. or lower.

### Polyethylene-Based Resin Packaging Material

The polyethylene-based resin packaging material (hereinafter, referred to as “PE-based resin packaging material”) according to the embodiment of the present invention is a packaging material formed from the PE-based resin composition according to the embodiment of the present invention. As aspects of the PE-based resin packaging material according to the embodiment of the present invention, known aspects can be adopted except that the PE-based resin composition according to the embodiment of the present invention is used.

Applications of the PE-based resin packaging material are not particularly limited, and a garbage bag, a shopping bag, a fashion bag, a storage bag, and a packing bag are exemplary examples.

As a method for producing the PE-based resin packaging material according to the embodiment of the present invention, a known method can be adopted except that the PE-based resin composition according to the embodiment of the present invention is used. A method of molding the PE-based resin composition according to the embodiment of the present invention into a film, and heat-sealing the film to make a bag is an exemplary example. As the method of molding into a film, inflation molding and T-die extrusion molding are exemplary examples.

The molding temperature (extrusion temperature) can be adjusted as appropriate, for example, 150° C. or higher and 190° C. or lower.

The thickness of the film may be appropriately set according to the application, and can be, for example, 10 µm or more and 70 µm or less.

As described above, in the present invention, the PE-based resin composition contains the copolymer A polymerized with a metallocene-based catalyst in a specific ratio. As a result, excellent moldability can be ensured even in a case where the amount of the inorganic compound is high, and a film excellent in bag-making processability and film strength is obtained. In addition, the PE-based resin packaging material obtained by using the PE-based resin composition according to the embodiment of the present invention can be produced with high productivity, and can withstand packaging and transportation of heavy objects.

Hereinafter, the present invention will be described in detail with reference to Examples, but the present invention is not limited to the following description.

### Abbreviation

The following abbreviations have the following meanings.

EO copolymer: ethylene-α-olefin copolymer

### (Copolymer A)

A-1: m-C6-LLDPE, trade name “D139FK”, manufactured by Chevron Phillips Chemical Company LLC., MFR: 1.0 g/10 min, melting point: 90° C.
A-2: m-C6-LLDPE, trade name “Evolue (registered trademark) 2320”, manufactured by Prime Polymer Co., Ltd., MFR: 1.8 g/10 min, melting point: 118° C.

### (Copolymer B)

B-1: C4-LLDPE, trade name “FS153S”, manufactured by Sumitomo Chemical Asia Pte Ltd.
B-2: C8-LLDPE, trade name “0138NK”, manufactured by Prime Polymer Co., Ltd.
B-3: product obtained by pulverizing a film in which the copolymer B-1 was molded, extruding the film into a strand with an extruder, and cutting the strand into pellets (assuming a recycled product)

### (Other Polymer C)

C-1: HDPE, trade name “FJ00952”, manufactured by SABIC
C-2: product obtained by pulverizing a film in which the copolymer C-1 was molded, extruding the film into a strand with an extruder, and cutting the strand into pellets (assuming a recycled product)

### (Masterbatch)

MB-3: masterbatch, trade name “GRANIC 422. calcium carbonate content: 80% by mass, C8-LLDPE content: 20% by mass, manufactured by GCR

### Production Example 1

80% by mass of calcium carbonate (Lighton BS-0, average particle size: 1.0 µm, manufactured by BIHOKU FUNKA KOGYO CO., LTD.) and 20% by mass of pellets of the copolymer B-2 (C8-LLDPE) were mixed in a super mixer for 5 minutes, the mixture was extruded into strands with a twin-screw extruder, and the strands were cut into pellets to obtain a masterbatch (MB-1).

### Production Example 2

A masterbatch (MB-2) was obtained in the same manner as in Production Example 1, except that the copolymer A-2 (m-C6-LLDPE) was used instead of the copolymer B-2.

### Example 1

As an inflation molding machine, an extruder (manufactured by Placo Co., Ltd.) having a cylinder inner diameter of 55 mm and a screw L/D of 32, and an annular die having a die diameter of 100 mmφ and a lip of 3 mm were used.

Each of raw materials was weighed so that MB-1 was 65% by mass, the copolymer B-1 (C4-LLDPE) was 25% by mass, and the copolymer A-1 (m-C6-LLDPE) was 10% by mass and fed into the extruder to prepare a PE-based resin composition, and a tubular film having a thickness of 25 µm and a folding width of 460 mm was molded by inflation molding. The extrusion temperature was 170° C., and the blow ratio was approximately 3.0. Next, the film was heat-sealed at intervals of 600 mm in a longitudinal direction by a bag-making machine (manufactured by Nozaki Kogyo Co., Ltd.), and was cut to produce a bag. The heat-sealing temperature was 160° C. or higher and 180° C. or lower.

The amount of calcium carbonate in the film (PE-based resin composition) was 52% by mass, the amount of the resin component was 48% by mass, the proportion of the ethylene-α-olefin copolymer in the resin component was 100% by mass, and the proportion of the copolymer A in the ethylene-α-olefin copolymer was 21% by mass.

### Examples 2 to 12

Bags were produced in the same manner as in Example 1, except that the composition of the PE-based resin composition was changed as shown in Table 1.

### Comparative Examples 1 to 6

Bags were produced in the same manner as in Example 1, except that the composition of the PE-based resin composition was changed as shown in Table 2.

### Film Moldability

The stability of the tube during film molding of each example was confirmed, and the moldability was evaluated according to the following standard.
“1”: more stable than normal resin (containing no inorganic compound)
“2”: stable like normal resin
“3”: slightly more unstable than normal resin, but capable of being continuously molded
“4”: unstable and not capable of being molded

### Bag-Making Processability

The production speed during bag making and the finished shape of the sealed portion were confirmed, and the moldability was evaluated according to the following standard.

“1”: the production speed and the finish of the sealed portion were improved as compared with a case without the inorganic substance.

“2”: the production speed and the finish of the sealed portion were equivalent to a case without the inorganic substance.

“3”: the finish of the seal shape was poor as compared with a case without the inorganic substance.

“4”: the production speed was very inferior to a case without the inorganic substance.

### Film Strength

The film molded in each example was pierced with a thumb, and the spread of the tear was observed in a case where force was applied to the pierced hole, and the film strength was evaluated according to the following standard.

### (Evaluation Standard)

“1”: the film could not be easily pierced.

“2”: the tear did not spread from the pierced hole.

“3”: the tear spread from the pierced hole.

“4”: a finger could be easily pierced.

Tables 1 and 2 show the composition of the PE-based resin composition, the thickness of the film, and the evaluation results of each example.

In Tables 1 and 2, “Calcium carbonate content” indicates the amount of calcium carbonate in the PE-based resin composition (film). “Resin component content” indicates the amount of the resin component in the PE-based resin composition (film).

TABLE 1

| | | Example | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Copolymer A | A-1 (m-C6-LLDPE) | 10 | 20 | | | 20 | 20 | | 10 | 20 | 10 | 15 | 30 |
| | A-2 (m-C6-LLDPE) | | | 15 | 25 | | | | | | | | |
| Copolymer B | B-1 (C4-LLDPE) | 25 | 15 | | | 20 | 35 | 10 | 60 | 50 | 20 | 15 | |
| | B-3 (C4-LLDPE) | | | | | | 15 | | | | | | |
| Other polymer | C-1 (HDPE) | | | 20 | 10 | | | | | | 5 | 5 | 5 |
| | C-2 (HDPE) | | | | | 20 | | | | | | | |
| Masterbatch | MB-1 (B-2 (C8-LLDPE): 20 wt%) | 65 | 65 | | | | | | | | | | |
| | MB-2 (A-2 (m-C6-LLDPE): 20 wt%) | | | 65 | 65 | 40 | 30 | 90 | | | | | |
| | MB-3 (CS-LLDPE: 20 wt%) | | | | | | | | 30 | 30 | 65 | 65 | 65 |
| Calcium carbonate content [% by mass] | | 52 | 52 | 52 | 52 | 32 | 24 | 72 | 24 | 24 | 52 | 52 | 52 |
| Resin component content [% by mass] | | 48 | 48 | 48 | 48 | 68 | 76 | 28 | 76 | 76 | 48 | 48 | 48 |
| Proportion of EO copolymer in resin component [% by mass] | | 100 | 100 | 58 | 79 | 71 | 100 | 100 | 100 | 100 | 90 | 90 | 90 |
| Proportion of copolymer A in EO copolymer [% by mass] | | 21 | 42 | 100 | 100 | 58 | 34 | 64 | 13 | 26 | 23 | 35 | 70 |
| Film thickness [µm] | | 25 | 25 | 25 | 25 | 25 | 25 | 25 | 25 | 25 | 25 | 25 | 25 |
| Film moldability | | 2 | 2 | 2 | 2 | 2 | 2 | 2 | 2 | 2 | 2 | 2 | 2 |
| Bag-making processability | | 2 | 2 | 2 | 2 | 2 | 2 | 2 | 2 | 2 | 2 | 2 | 2 |
| Film strength | | 2 | 2 | 2 | 2 | 2 | 2 | 2 | 2 | 2 | 2 | 2 | 2 |

TABLE 2

| | | Comparative Example | | | | | |
|---|---|---|---|---|---|---|---|
| | | 1 | 2 | 3 | 4 | 5 | 6 |
| Copolymer A | A-1 (m-C6-LLDPE) | | | 5 | | 90 | |
| | A-2 (m-C6-LLDPE) | | | | | | |
| Copolymer B | B-1 (C4-LLDPE) | 35 | | | | | 70 |
| | B-3 (CA-LLDPE) | | | | | | |
| Other polymer | C-1 (HDPE) | | 35 | 30 | | | |
| | C-2 (HDPE) | | | | | | |
| Masterbatch | MB-1 (B-2 (C8-LLDPE): 20 wt%) | 65 | 65 | 65 | | 10 | |
| | MB-2 (A-2 (m-C6- LLDPE): 20 wt%) | | | | 100 | | 30 |
| | MB-3 (C8-LLDPE: 20 wt%) | | | | | | |
| Calcium carbonate content [% by mass] | | 52 | 52 | 52 | 80 | 8 | 24 |
| Resin component content [% by mass] | | 48 | 48 | 48 | 20 | 92 | 76 |
| Proportion of EO copolymer in resin component [% by mass] | | 100 | 27 | 38 | 100 | 100 | 100 |
| Proportion of copolymer A in EO copolymer [% by mass] | | 0 | 0 | 28 | 100 | 98 | 8 |
| Film thickness [µm] | | 25 | 25 | 25 | 25 | 25 | 25 |
| Film moldability | | 2 | 2 | 2 | 4 | 4 | 2 |
| Bag-making processability | | 2 | 2 | 2 | 2 | 4 | 2 |
| Film strength | | 3 | 4 | 3 | 4 | 2 | 3 |

As shown in Tables 1 and 2, in Examples 1 to 12 in which the copolymer A was contained in a specific ratio, the film moldability, the bag-making processability, and the film strength were all excellent even in a case where the calcium carbonate was contained in a large amount.

On the other hand, in Comparative Examples 1 and 2 in which the PE-based resin composition did not contain the copolymer A, and in Comparative Example 3 in which the proportion of the ethylene-α-olefin copolymer in the resin component was low, the film strength was inferior. In Comparative Example 4 in which the amount of the resin component was low, the film moldability was inferior, and the film strength was also inferior. In Comparative Example 5 in which the proportion of the resin component in the PE-based resin composition was high, the film moldability and the bag-making processability were inferior. In Comparative Example 6 in which the proportion of the copolymer A in the ethylene-α-olefin copolymer was low, the film strength was inferior.

What is claimed is:

1. A polyethylene-based resin composition comprising:
an inorganic compound; and
a resin component,
wherein an amount of the resin component is 25% by mass or more and less than 90% by mass with respect to a total mass of the resin composition,
the resin component includes an ethylene-α-olefin copolymer in an amount of 50% by mass or more with respect to a total mass of the resin component and a high-density polyethylene in an amount of 5% by mass or more and 50% by mass or less with respect to a total mass of the resin component .

2. The polyethylene-based resin composition according to claim 1,
wherein α-olefin used in the ethylene-α-olefin copolymer A has 6 or more and 8 or less carbon atoms.

3. The polyethylene-based resin composition according to claim 1, wherein the inorganic compound is calcium carbonate.

4. A polyethylene-based resin packaging material formed from the polyethylene-based resin composition according to claim 1.

5. The polyethylene-based resin packaging material according to claim 4,
wherein the polyethylene-based resin packaging material is for a garbage bag, a shopping bag, a fashion bag, a storage bag, or a packing bag.

6. A method for producing a polyethylene-based resin composition containing an inorganic compound and a resin component, the method comprising:
mixing the resin component and the inorganic compound in amounts in which an amount of the resin component is 25% by mass or more and less than 90% by mass with respect to a total mass of the resin composition,
wherein the resin component includes an ethylene-α-olefin copolymer in an amount of 50% by mass or more with respect to a total mass of the resin component and a high-density polyethylene in an amount of 5% by mass or more and 50% by mass or less with respect to a total mass of the resin component .

7. A method for producing a polyethylene-based resin packaging material, comprising:
producing a polyethylene-based resin composition by the method for producing a polyethylene-based resin composition according to claim 6; and
molding the polyethylene-based resin composition to obtain a polyethylene-based resin packaging material.
